(19) United States
(12) Patent Application Publication
(10) Pub. No.: US 2020/0375120 A1
(43) Pub. Date: Dec. 3, 2020

(54) CARTS FOR SUPPORTING INDOOR GROWTH OF PLANTS, MODULAR PLANT GROWING SYSTEMS INCLUDING THE CARTS, AND METHODS OF GROWING PLANTS INDOORS

(71) Applicant: Forward Greens Inc., Vancouver, WA (US)

(72) Inventor: Tetsuya Kenneth Kaneko, Vancouver, WA (US)

(21) Appl. No.: 16/882,124

(22) Filed: May 22, 2020

Related U.S. Application Data
(60) Provisional application No. 62/853,391, filed on May 28, 2019.

(51) Int. Cl. A01G 9/02; A01G 7/04; A01G 27/00; B62B 3/00

(52) U.S. Cl. CPC A01G 9/023; A01G 7/045; B62B 2202/70; B62B 3/002; A01G 27/003

(57) ABSTRACT

Carts for supporting indoor growth of plants, modular plant growing systems including the carts, and methods of growing plants indoors are disclosed herein. The carts include a support frame, a plurality of light sources, an electrical input structure, an irrigation water distribution manifold, and an irrigation water collection manifold. The modular plant growing systems include a racking system and the carts. The methods include positioning a plurality of plants, positioning at least one flood tray, positioning a cart, fluidly interconnecting a water source, electrically interconnecting an electrical outlet to an electrical input structure, and promoting growth.

### RELATED APPLICATION

This application claims priority to U.S. Provisional Patent Application No. 62/853,391, which was filed on May 28, 2019, and the complete disclosure of which is hereby incorporated by reference.

### FIELD OF THE DISCLOSURE

The present disclosure relates generally to carts for supporting indoor growth of plants, to modular plant growing systems that include the carts, and/or to methods of growing plants indoors.

### BACKGROUND OF THE DISCLOSURE

Plants may be grown under a variety of conditions. Historically, plants have been grown outdoors, where rainwater and/or moisture that is naturally present in the soil may provide at least a portion of the plants' water requirements and sunlight may provide the plants' light requirements. While effective with certain plants and/or in certain climates, outdoor plant growth may be ineffective in others. Additionally or alternatively, diseases and/or pests may be difficult to control when plants are grown outdoors.

Growing conditions for plants may be controlled and/or regulated in a number of ways. As an example, irrigation water may be provided to the plants to supplement natural water sources. As another example, sunlight exposure may be regulated via shade structures. As yet another example, diseases and/or pests may be controlled and/or excluded via chemical and/or physical mechanisms.

In some circumstances, it may be desirable to grow plants in an indoor environment. In such indoor environments, moisture, light exposure, disease exposure, and/or pest exposure may be more readily controlled and/or regulated. However, indoor growth environments present unique challenges. As an example, it may be costly to provide the infrastructure needed to effectively grow plants indoors. As another example, it may be difficult to efficiently utilize space and/or other resources. As yet another example, handling costs may increase. Thus, there exists a need for carts for supporting indoor growth of plants, for modular plant growing systems that include the carts, and/or for methods of growing plants indoors.

### SUMMARY OF THE DISCLOSURE

Carts for supporting indoor growth of plants, modular plant growing systems including the carts, and methods of growing plants indoors are disclosed herein. The carts include a support frame, a plurality of light sources, an electrical input structure, an irrigation water distribution manifold, and an irrigation water collection manifold. The support frame includes a plurality of tray support regions. The plurality of light sources is operatively attached to the support frame, and at least one light source of the plurality of light sources is positioned vertically above each tray support region of the plurality of tray support regions. The electrical input structure is configured to receive an electric current and includes a pair of spaced-apart contacting structures that are spaced apart from one another in at least two dimensions. The irrigation water distribution manifold is configured to provide irrigation water to each tray support region of the plurality of tray support regions. The irrigation water collection manifold is configured to receive unused irrigation water from each tray support region. The irrigation water distribution manifold and the irrigation water collection manifold are positioned such that irrigation water flows from an inlet of the irrigation water distribution manifold to an outlet from the irrigation water collection manifold under the influence of gravity.

The modular plant growing systems include a racking system and a plurality of carts. The racking system includes a plurality of shelves and a plurality of electrical outlets. Each electrical outlet includes a plurality of bus bars including a first bus bar and a second bus bar. Each cart includes a support frame, a plurality of light sources, an electrical input structure, an irrigation water distribution manifold, and an irrigation water collection manifold. The electrical input structure is configured to receive an electric current and includes a pair of spaced-apart contacting structures. The plurality of bus bars is positioned to automatically form an electrical connection with the pair of spaced-apart contacting structures of a corresponding cart when the corresponding cart is fully inserted into a corresponding shelf of the plurality of shelves.

The methods include positioning a plurality of plants within growth media and on a plurality of flood trays. The methods also include positioning at least one flood tray of the plurality of flood trays on each tray support region of a plurality of tray support regions of a cart. The methods further include positioning the cart on a corresponding shelf of a racking system, fluidly interconnecting a water source with an irrigation water distribution manifold of the cart, electrically interconnecting an electrical outlet to an electrical input structure of the cart, and promoting growth of the plurality of plants. The electrically interconnecting is responsive to the positioning the cart.

### BRIEF DESCRIPTION OF THE DRAWINGS

FIG. 1 is a schematic illustration of examples of a modular growing system that may include a plurality of carts, according to the present disclosure.

FIG. 2 is a schematic illustration of examples of a cart according to the present disclosure.

FIG. 3 is a less schematic perspective view illustrating an example of a cart according to the present disclosure.

FIG. 4 is a less schematic perspective view illustrating the cart of FIG. 3 supporting a plurality of flood trays.

FIG. 5 is a less schematic illustration of a cart being positioned on a shelf of a racking system, according to the present disclosure.

FIG. 6 is a flowchart depicting examples of methods, according to the present disclosure, of growing plants indoors.

### DETAILED DESCRIPTION AND BEST MODE OF THE DISCLOSURE

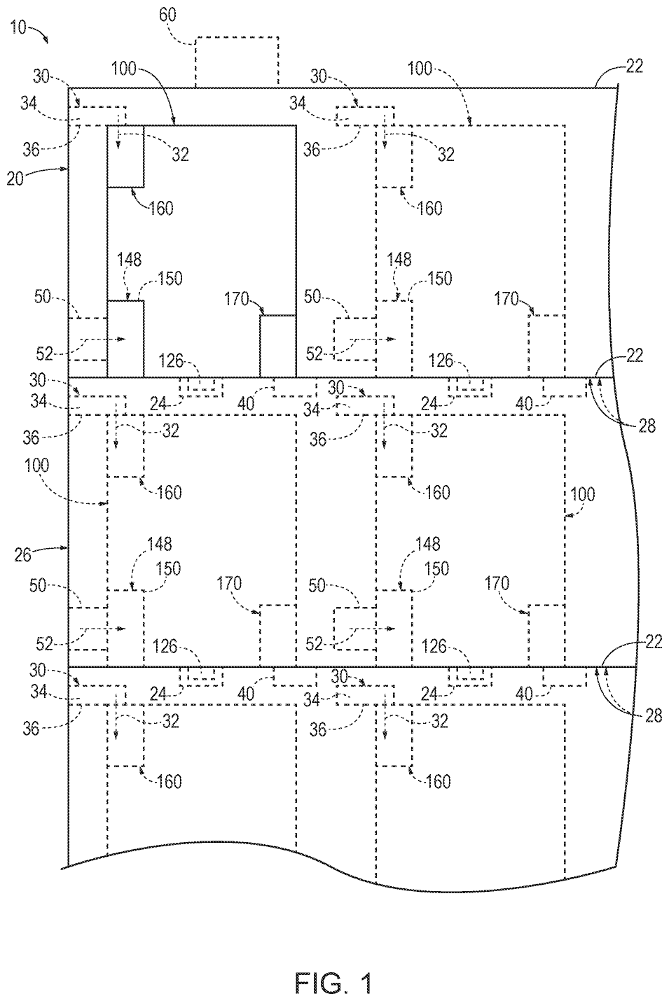

FIGS. 1-5 provide examples of modular plant growing systems 10, of carts 100, and/or of methods 300, according to the present disclosure. Elements that serve a similar, or at least substantially similar, purpose are labeled with like numbers in each of FIGS. 1-5, and these elements may not be discussed in detail herein with reference to each of FIGS. 1-5. Similarly, all elements may not be labeled in each of FIGS. 1-5, but reference numerals associated therewith may be utilized herein for consistency. Elements, components, and/or features that are discussed herein with reference to one or more of FIGS. 1-5 may be included in and/or utilized with any of FIGS. 1-5 without departing from the scope of the present disclosure. In general, elements that are likely to be included in a particular embodiment are illustrated in solid lines, while elements that are optional are illustrated in dashed lines. However, elements that are shown in solid lines may not be essential and, in some embodiments, may be omitted without departing from the scope of the present disclosure.

FIG. 1 is a schematic illustration of examples of a modular plant growing system 10 that may include a plurality of carts 100, according to the present disclosure. Modular plant growing systems 10 include a racking system 20 that includes, has, and/or defines a plurality of shelves 22. Modular plant growing system 10 also includes at least one cart 100, examples of which are discussed in more detail herein. In some examples, modular plant growing system 10 includes a plurality of carts 100, which may be supported by racking system 20 in an at least 2-dimensional array of carts.

As illustrated in dashed lines in FIG. 1, modular plant growing system 10 may include a water source 30. Water source 30 may be configured to provide irrigation water 32 to a corresponding irrigation water distribution manifold 160 of each cart 100. Water source 30 may include a plurality of water connections 34. Each water connection 34 may be configured to be selectively engaged with a corresponding irrigation water distribution manifold 160 of each cart 100, such as to provide irrigation water 32 to the corresponding irrigation water distribution manifold. Additionally or alternatively, each water connection 34 may be configured to be selectively disengaged from the corresponding irrigation water distribution manifold, such as to cease supply of irrigation water 32 to the corresponding irrigation water distribution manifold and/or to permit corresponding cart 100 to be removed and/or separated from racking system 20. With this in mind, water connections 34 may include and/or be a valve 36 that may be configured to selectively restrict flow of irrigation water 32 therethrough. Such a configuration may permit and/or facilitate supply of irrigation water 32 to selected carts 100, which may be positioned within racking system 20 and/or may be supporting plants, while avoiding loss of irrigation water from water connections 34 that presently are not associated with and/or connected to a corresponding cart 100.

Water source 30 may include any suitable structure that may be adapted, configured, designed, and/or constructed to provide irrigation water 32 to cart 100. Examples of water source 30 include a water storage tank, a facilities water connection, a water filtration system, a water purification system, and/or a water sterilization system, as well as any suitable tubing, fluid conduit, pump, valve, and the like.

As also illustrated in dashed lines in FIG. 1, modular plant growing system 10 may include a drain system 40. Drain system 40 may be configured to receive irrigation water 32 from a corresponding irrigation water collection manifold 170 of each cart 100. As an example, and as discussed in more detail herein, carts 100 may include a plurality of flood trays. In this configuration, irrigation water distribution manifold 160 may provide irrigation water 32 to the flood trays and irrigation water collection manifold 170 may receive the irrigation water, or unused irrigation water, from the flood trays.

Drain system 40 may include any suitable structure that may be adapted, configured, designed, and/or constructed to receive irrigation water 32 from cart 100 and/or from the flood trays of the cart. Examples of drain system 40 include a water collection tray and/or a water reservoir, as well as any suitable tubing, fluid conduit, pump, valve, and the like.

In some examples, and as discussed in more detail herein, cart 100, irrigation water distribution manifold 160, and/or irrigation water collection manifold 170 may be configured to gravity feed irrigation water 32 to the plurality of flood trays. As an example, an inlet to irrigation water distribution manifold 160 may be at a top of cart 100, may be within an upper region of cart 100, and/or may be positioned vertically above an uppermost flood tray of cart 100 and/or vertically above an uppermost tray support region of the cart. In addition, an outlet from irrigation water collection manifold 170 may be at a bottom of cart 100, may be within a lower region of cart 100, and/or may be positioned vertically below a lowermost flood tray of cart 100. In such a configuration, irrigation water 32 may flow from the inlet to the irrigation water distribution manifold to the outlet from the irrigation water collection manifold under the influence of gravity.

In some examples, racking system 20 and/or carts 100 may be configured to connect, or to automatically connect, water connection 34 to irrigation water distribution manifold 160 and/or to connect, or to automatically connect, drain system 40 to irrigation water collection manifold 170. This automatic connection may occur when carts 100 are positioned, or properly positioned, on shelves 22 and/or within racking system 20. In such a configuration, valve 36 may be configured to automatically block flow of irrigation water 32 when cart 100 is not positioned within racking system 20 and/or to automatically permit flow of the irrigation water to cart 100 when the cart is positioned within the racking system. As an example, valve 36 may include and/or be a normally closed valve that is opened via a mechanical valve actuator, and cart 100 may be configured to actuate the mechanical valve actuator upon being positioned within the racking system. As another example, valve 36 may include and/or be an electrically powered valve that may be automatically transitioned to a closed state when cart 100 is not positioned within racking system 20 and to an open state when cart 100 is positioned within the racking system.

As also illustrated in dashed lines in FIG. 1, modular plant growing system 10 may include a plurality of electrical outlets 50. Each electrical outlet 50 may be configured to interconnect with, or to electrically interconnect with, an electrical input structure 148 of a corresponding cart 100, such as to provide an electric current 52 to the corresponding cart. As an example, and as discussed in more detail herein, carts 100 may include cart light source drivers 150, and electrical outlets 50 may be configured to provide the electric current to the cart light source drivers, such as to electrically power the cart light source drivers. In some such examples, electrical outlets 50 may provide, or may be configured to provide, electric current 52 in the form of a line electric current, an AC electric current, and/or an AC line electric current, which may be provided at a line voltage of at least 100 volts, at least 200 volts, at least 300 volts, or at least 400 volts.

As another example, and as also discussed in more detail herein, racking system 20 may include a rack light source driver 60, and electrical outlets 50 may be configured to provide the electric current from the rack light source driver to the carts and/or to light sources of the carts. In some such examples, carts 100 may not include cart light source drivers 150. In some such examples, electrical outlets 50 may provide, or may be configured to provide, electric current 52 in a form that may be received and/or utilized by the light sources, an example of which include a DC electric current, which may be provided at a DC voltage of at least 3 volts, at least 5 volts, at least 10 volts, at least 15 volts, at least 20 volts, at least 30 volts, at least 40 volts, at most 100 volts, at most 90 volts, at most 80 volts, at most 70 volts, at most 60 volts, at most 50 volts, at most 40 volts, at most 30 volts, and/or at most 20 volts. Examples of rack light source driver 60 are disclosed herein with reference to cart light source driver 150; however, and in contrast with cart light source driver 150, when racking systems 20 include the rack light source driver, the rack light source driver may be configured and/or sized to provide electric current 52 to a plurality of carts 100 or even to every cart 100 that is positioned on and/or within a given racking system 20. With this in mind, rack light source driver 60 may be larger and/or may be configured to provide a larger electric current when compared to cart light source driver 150.

In some examples, carts 100 may include a corresponding plug that may be configured to be plugged, or manually plugged, into electrical outlets 50. In some examples, electrical outlets 50 may include and/or be an electrical bus bar, which may be configured to automatically form the electrical connection with carts 100 when carts 100 are positioned, or properly positioned, on shelves 22 and/or within racking system 20. Such a configuration may permit and/or facilitate automatic supply of electric current 52 to carts 100, thereby decreasing and/or eliminating a labor cost that may be associated with manually forming the electrical connection, such as by plugging the cart into the electrical outlet.

As also illustrated in dashed lines in FIG. 1, modular plant growing system 10 and/or racking system 20 thereof may include and/or define a plurality of support frame receptacles 24. Each support frame receptacle 24 may be configured to operatively interlock with a corresponding frame interlock structure 126 of a corresponding cart 100, such as to retain carts 100 within racking system 20, to resist inadvertent, unintended, and/or unexpected separation of carts 100 from racking system 20, and/or to direct the cart to a desired orientation relative to the racking system. Examples of support frame receptacles 24 include a chute, a guide, and/or a linear guide.

Additionally or alternatively, support frame receptacles 24 may be configured to direct and/or urge carts 100 to a predetermined and/or desired orientation relative to racking system 20 and/or shelves 22 thereof. Such a configuration may permit and/or facilitate automatic supply of irrigation water 32 and/or of electric current 52 to carts 100 when carts 100 are positioned, properly positioned, and/or fully positioned within racking system 20.

Racking system 20 may include any suitable structure that may include, may be operatively attached to, and/or may support shelves 22, support frame receptacle 24, water source 30, drain system 40, electrical outlet 50, and/or rack light source driver 60. An example of racking system 20 includes pallet racking.

Racking system 20 may include at least one vertical 26, which also may be referred to herein as a vertical support member 26, and a plurality of horizontals 28, which also may be referred to herein as horizontal support members 28. Vertical 26 may support, or operatively support, horizontals 28, such as by being operatively attached to the horizontals. Horizontals 28 may form and/or at least partially define shelves 22. Racking system 20 may include a plurality of horizontals 28 for each shelf 22. In some examples, the plurality of horizontals 28 may include 2, or at least 2, horizontals 28. In some examples, the plurality of horizontals 28 may include 3 horizontals 28, as discussed in more detail herein.

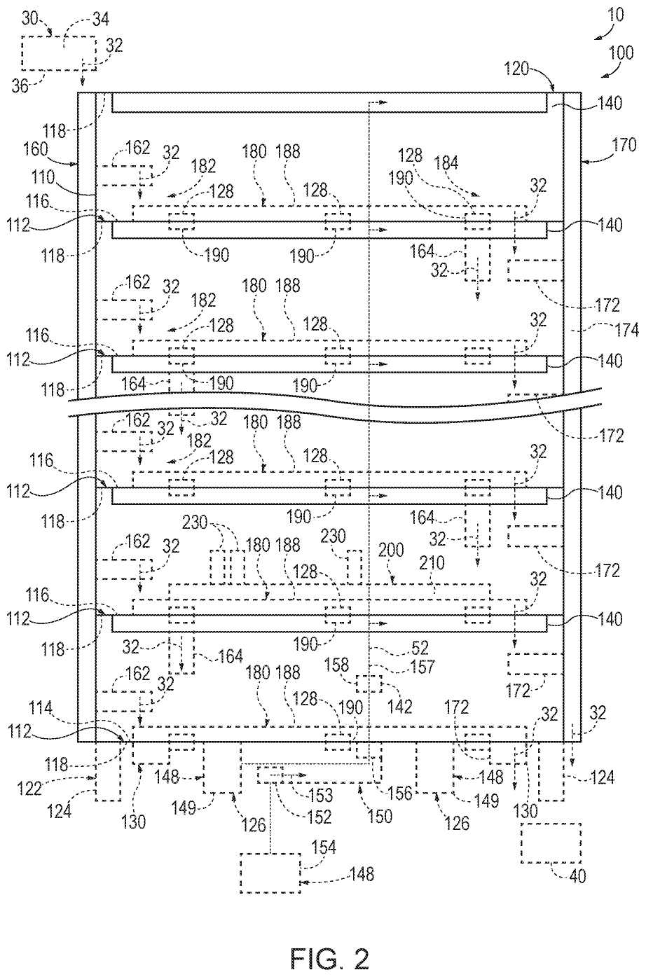

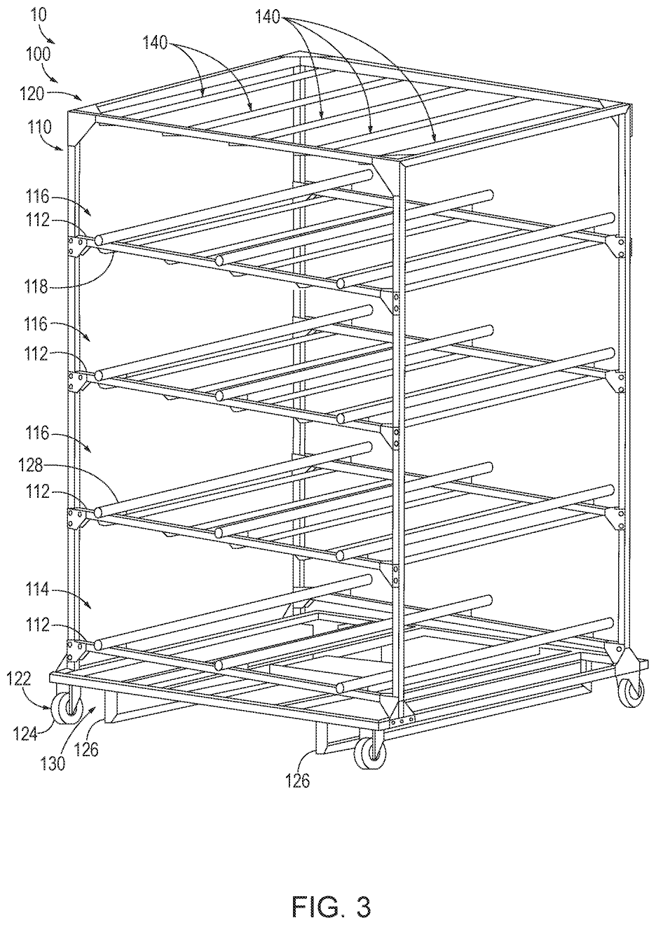

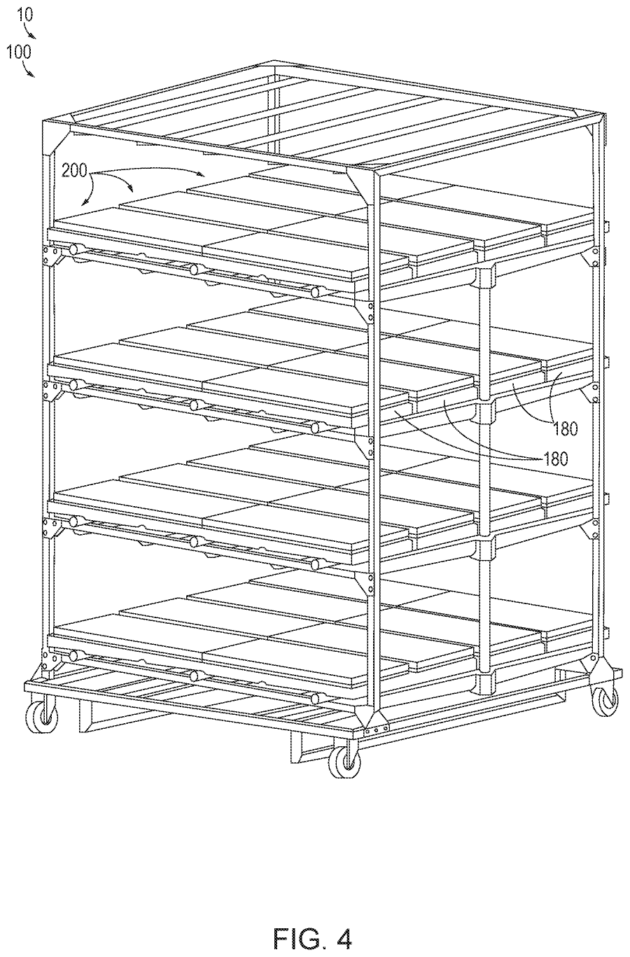

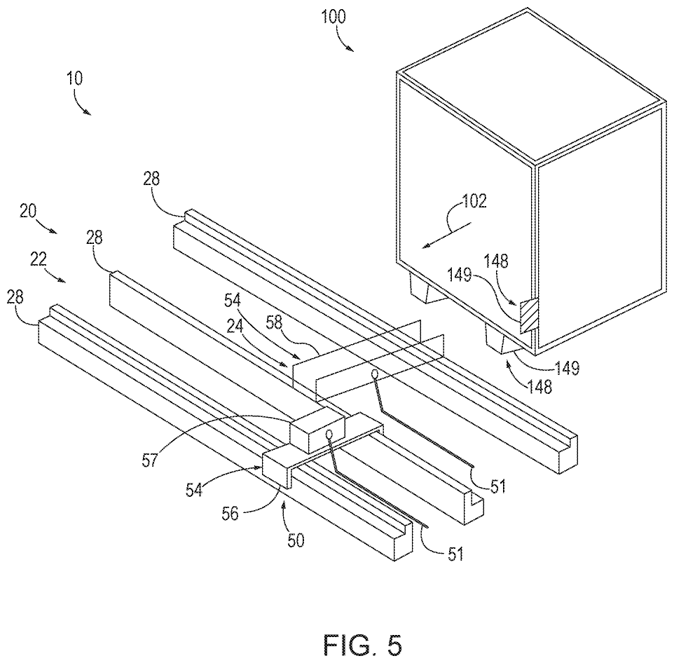

FIG. 2 is a schematic illustration of examples of a cart 100 according to the present disclosure. FIG. 3 is a less schematic perspective view illustrating an example of a cart 100 according to the present disclosure, while FIG. 4 is a less schematic perspective view illustrating the cart 100 of FIG. 3 supporting a plurality of flood trays 180. FIG. 5 is a less schematic illustration of a cart 100 being positioned on a shelf 22 of a racking system 20, according to the present disclosure.

Carts 100 of FIGS. 2-5 may include and/or be more detailed and/or less schematic views of carts 100 of FIG. 1. With this in mind, any of the structures, functions, and/or features disclosed herein with any of carts 100 of FIGS. 2-5 may be included in and/or utilized with carts 100 of FIG. 1 without departing from the scope of the present disclosure. Similarly, any of the structures, functions, and/or features disclosed herein with reference to modular plant growing systems 10 and/or carts 100 of FIG. 1 may be included in and/or utilized with carts 100 of FIGS. 2-5 without departing from the scope of the present disclosure.

Carts 100 may be configured, or may be referred to herein as being configured, to support growth of plants 220, such as by physically supporting the plants, supporting photosynthesis within the plants, providing water to the plants, providing nutrients to the plants, and/or providing light to the plants. Turning to the schematic illustration of FIG. 2, and with general reference to the less schematic illustrations of FIGS. 3-5, carts 100 include a support frame 110 that includes and/or defines a plurality of tray support regions 112. Carts 100 also include a plurality of light sources 140. Light sources 140 may be operatively attached to support frame 110, and at least one light source 140 may be positioned vertically above each tray support region 112.

As discussed, carts 100 may include an electrical input structure 148. Electrical input structure 148 may be configured to receive the electric current from electrical outlet 50 and/or to provide the electric current to one or more other structures of the cart. Examples of electrical input structure 148 include any suitable plug, contacting structure, spring-loaded contacting structure, and/or electrically conductive contacting structure.

Carts 100 may include a cart light source driver 150. Cart light source driver 150, when present, may be operatively attached to support frame 110 and may include a driver electrical input 152, which may be configured to receive an input electric current 153, and driver electrical output 156, which may be configured to provide an output electric current 157 to light sources 140.

Carts 100 also include an irrigation water distribution manifold 160 and an irrigation water collection manifold 170. Irrigation water distribution manifold 160 may be configured to provide irrigation water 32 to each tray support region 112, while irrigation water collection manifold 170 may be configured to receive unused irrigation water 32 from each tray support region 112.

During operation of carts 100 and/or of modular plant growing systems 10 that include carts 100, carts 100 initially may be separated from racking system 20 and/or may not be positioned on shelves 22 of racking system 20. However, each cart 100 still may include at least a corresponding support frame 110, corresponding light sources 140, a corresponding cart light source driver 150, a corresponding irrigation water distribution manifold 160, and/or a corresponding irrigation water collection manifold 170.

In this configuration, it may be convenient and/or desirable to clean carts 100, to clean one or more components of carts 100, and/or to prepare carts 100 for growing plants 220. As an example, flood trays 180 may be positioned upon corresponding tray support regions 112. Prior and/or subsequent to the flood trays being positioned on the tray support regions, growth media 210 and plants 220 may be positioned upon flood trays 180. This may include positioning the growth media in containers 200 and subsequently positioning the containers on the flood trays and/or directly positioning the growth media on the flood trays. Once all, or all desired, flood trays 180 and corresponding plants 220 have been positioned on and/or within cart 100, the cart may be positioned within racking system 20, as illustrated in FIG. 1. A corresponding irrigation water distribution manifold 160 of the cart then may be fluidly interconnected with a corresponding water connection 34, a corresponding irrigation water collection manifold 170 of the cart then may be fluidly interconnected with drain system 40, and/or an electrical connection may be established between cart 100 and a corresponding electrical outlet 50. As discussed in more detail herein, the water and/or electrical connections may be manually and/or automatically established. When the water and/or electrical connections are automatically established, the automatic connection may be responsive to and/or a result of the cart being positioned within the racking system. Subsequently, plants 220 may be selectively watered and/or illuminated by the modular plant growing system, such as to permit, to facilitate, and/or to encourage growth of the plants.

After a desired amount of growth has been achieved, the corresponding irrigation water distribution manifold may be disconnected from the corresponding water connection, the corresponding irrigation water collection manifold may be disconnected from the drain system, and/or the electrical connection between the corresponding electrical outlet and the cart may be disconnected. Once again, the water and/or electrical disconnection may be manual or automatic. When the water and/or electrical disconnection is automatic, the disconnection may be responsive to and/or a result of the cart being removed and/or separated from the racking system.

Plants that are supported by the cart then may be harvested. The above-described cycle may be repeated, thereby providing efficient and/or modular indoor plant growth.

Support frame 110 may include and/or be any suitable structure that may define tray support regions 112 and/or that may be operatively attached to and/or that may support light sources 140, cart light source driver 150, irrigation water distribution manifold 160, and/or irrigation water collection manifold 170. In some examples, support frame 110 may include and/or be a tubular, or an at least partially tubular, support frame.

Support frame 110 may include and/or define a lower tray support region 114 and a plurality of upper tray support regions 116. In such a configuration, cart light source driver 150, when present, may be operatively attached to, or to an underside 118 of, lower tray support region 114. Additionally or alternatively, a corresponding light source 140 may be operatively attached to, or to an underside 118 of, each upper tray support region 116.

As illustrated, support frame 110 also may include an upper light source support region 120. Upper light source support region 120 may be positioned above, or vertically above, an uppermost upper tray support region 116 and/or an upper, or an upper most, light source 140 may be operatively attached to the light source support region. Such a configuration may permit and/or facilitate illumination of each, or of every, tray support region 112 via a corresponding light source 140.

It is within the scope of the present disclosure that tray support regions 112 may be vertically arranged on top of one another within support frame 110. Stated another way, the tray support regions may form and/or define a vertical stack of tray support regions. Stated yet another way, the tray support regions may be parallel, or at least substantially parallel, to one another and may be spaced-apart from one another in the vertical direction. Such a configuration may permit and/or facilitate a compact cart 100, may permit a high density of plants to be supported by a given cart 100, and/or may permit and/or facilitate flood irrigation of plants supported by cart 100. As examples, carts 100 may permit at least 2, at least 3, at least 4, at least 6, at least 8, at most 20, at most 15, at most 10, at most 8, at most 6, at most 5, and/or at most 4 times as many plants to be grown within a footprint of the cart when compared to growing plants on the ground and/or growing on a cart with only a single tray support region.

Support frame 110 may include and/or define any suitable shape. As an example, and as illustrated, support frame 110 may be rectangular when viewed from the side. As another example, and as also illustrated, support frame 110 may be rectangular, at least substantially square, or square when viewed from above and/or from below. Stated another way, support frame 110 may define a square, or an at least substantially square, frame footprint.

Support frame 110 may include and/or define any suitable number of tray support regions 112, with a number of tray support regions in a given cart 100 being selected based upon a desired overall height for the given cart and/or on a desired height for plants 220 prior to harvest. As examples, support frame 110 may define at least 2, at least 3, at least 4, at least 6, at least 8, at most 20, at most 15, at most 10, at most 8, at most 6, at most 5, and/or at most 4 tray support regions 112.

In some examples, carts 100 may include a mobile base 122. Mobile base 122, when present, may be configured to permit and/or facilitate convenient, ergonomic, and/or efficient motion, transfer, and/or conveyance of carts 100 and may include any suitable structure. As an example, mobile base 122 may include a plurality of casters 124 configured to facilitate rolling of the cart across a ground surface.

In some examples, carts 100 and/or support frame 110 thereof may include frame interlock structure 126. Frame interlock structure 126 may be configured to operatively interlock support frame 110 with racking system 20 and/or support frame receptacle 24 thereof, as discussed in more detail herein with reference to FIG. 1. Additionally or alternatively, and as also discussed in more detail herein with reference to FIG. 1, frame interlock structure 126 and support frame receptacle 24 together may be configured to urge carts 100 to the predetermined and/or desired orientation relative to the racking system when positioned therewithin.

In some examples, frame interlock structure 126 may include and/or be a frame interlock projection that projects from and/or below lower tray support region 114. In such a configuration, the frame interlock projection may project into the support frame receptacle, thereby operatively interlocking the support frame and the racking system.

In some examples, carts 100 and/or support frame 110 thereof may include and/or define a tray interlock structure 128. Tray interlock structure 128 may be configured to operatively interlock each tray support region 112 with at least one corresponding flood tray 180, examples of which are discussed in more detail herein.

In some examples, carts 100 and/or support frame 110 thereof may include and/or define at least one forklift receptacle 130 or even a pair of forklift receptacles 130. Forklift receptacles 130 may be configured to permit a forklift to selectively position cart 100 on the racking system and/or to selectively remove the cart from the racking system. This selective positioning and/or removal may include lifting the cart at least a threshold distance to disengage the frame interlock structure from the support frame receptacle and subsequently translating the cart in a horizontal direction and/or away from the racking system.

Light sources 140 may include any suitable structure that may be operatively attached to support frame 110, that may be positioned vertically above tray support regions 112, and/or that may be adapted, configured, and/or selected to illuminate, or to selectively illuminate, plants 220. In some examples, a plurality of corresponding light sources 140 may be positioned vertically above each tray support region 112. In such a configuration, a number of light sources in the plurality of light sources may be selected based upon a desired intensity and/or uniformity of light that illuminates the plants. Examples of the plurality of corresponding light sources include at least 2, at least 3, at least 4, at least 5, at most 8, at most 6, at most 5, at most 4, and/or at most 3 light sources.

Examples of light sources 140 include light emitting diode arrays. Such light emitting diode arrays may be arranged in any suitable fashion. As an example, the plurality of light emitting diode arrays may include a plurality of linear light emitting diode arrays.

Cart light source driver 150, when present, may include any suitable structure that may be operatively attached to support frame 110, that may include driver electrical input 152, that may be configured to receive input electric current 153, that may include driver electrical output 156, and/or that may provide output electric current 157 to light sources 140. As an example, and when light sources 140 include light emitting diodes, cart light source driver 150 may include and/or be a light emitting diode cart light source driver. Cart light source driver 150 may include an input plug 154, which may be configured to electrically interconnect to the electrical outlet of the racking system and/or to convey the input electric current to the cart light source driver. In some such examples, input plug 154 may function as and/or may be electrical input structure 148. Cart light source driver 150 additionally or alternatively may include a driver outlet plug 158, which may be configured to electrically interconnect with a corresponding light source plug 142 of a corresponding light source 140.

Cart light source driver 150 may produce and/or generate driver electrical output 156 in any suitable manner. As an example, the cart light source driver may modify input electric current 153 to produce and/or generate the output electric current. This may include modification of the voltage of the input electric current, modification of the amperage of the input electric current and/or AC to DC conversion of the input electric current, and/or DC to AC conversion of the input electric current to produce and/or generate the output electric current.

Irrigation water distribution manifold 160 may include any suitable structure that may be adapted, configured, designed, and/or constructed to provide irrigation water 32 to tray support regions 112 and/or to flood trays 180 that may be positioned on and/or supported by tray support regions 112. As an example, irrigation water distribution manifold 160 may include a plurality of emitters 162, and at least one emitter may be configured to provide irrigation water to each tray support region and/or to each flood tray. Such a configuration may be referred to herein as a parallel flow irrigation configuration.

As another example, irrigation water distribution manifold 160 may be configured initially to provide the irrigation water to an upper, or an uppermost, flood tray 180, and the irrigation water distribution manifold further may include at least one cascade connection 164 that may be configured to provide the irrigation water from the upper flood tray to another flood tray that is vertically below the upper flood tray. Such a configuration may be referred to herein as a series flow and/or as a cascade flow irrigation configuration.

Irrigation water collection manifold 170 may include any suitable structure that may be adapted, configured, designed, and/or constructed to receive irrigation water 32, or unused irrigation water 32, from tray support regions 112 and/or from flood trays 180 that may be positioned on and/or supported by tray support regions 112. As an example, and such as when irrigation water distribution manifold 160 includes the parallel flow irrigation configuration, irrigation water collection manifold 170 may include a plurality of elongate irrigation water collection trays 172. In such a configuration, each elongate water collection tray may be configured to extend along a length of at least one side of a corresponding tray support region 112 and/or to collect irrigation water from each flood tray 180 that is supported by the tray support region. As another example, irrigation water collection manifold 170 may include a drain conduit 174 that may be configured to collect irrigation water from elongate irrigation water collection trays 172. As yet another example, and when irrigation water distribution manifold 160 includes the series flow irrigation configuration, irrigation water collection manifold 170 may include a single elongate irrigation water collection tray 172, which may be associated with a lowermost flood tray 180 and/or the lowermost flood tray 180 may be configured to provide the irrigation water directly to drain conduit 174.

As illustrated in dashed lines in FIG. 2 and in solid lines in FIG. 4, cart 100 may include, and/or tray support regions 112 may support, flood trays 180. Each tray support region 112 may support at least one flood tray 180; and, in some examples, each tray support region 112 may support a plurality of flood trays 180. As examples, each tray support region 112 may support at least 2, at least 3, at least 4, at least 5, at least 6, at most 8, at most 6, at most 5, at most 4, and/or at most 3 elongate flood trays. When tray support regions 112 support a plurality of flood trays 180, each flood tray may be rectangular, or at least substantially rectangular, in shape and may be referred to herein as an elongate flood tray 180. Elongate flood trays 180 may be arranged, within each tray support region 112, in a square, or an at least substantially square, shape and/or may be utilized to facilitate and/or simplify handling and/or cleaning of the flood trays.

As an example, a given tray support region 112 may be square, or at least substantially square, and may have sides that are approximately 1.2 meters long. In such a configuration, utilization of elongate flood trays, each of which may be approximately 1.2 meters long and 0.3 meters wide, may make it easier for an operator to handle the flood trays and/or may permit cleaning of the flood trays with commercially available cleaning equipment, which may not be suitable for cleaning square flood trays that may extend beyond 1.2 meters on each side.

Flood trays 180 may include and/or define an irrigation water-receiving region 182 and an irrigation water-discharge region 184. Irrigation water-receiving region 182 may be arranged on a first side of the flood tray, which may be proximal to irrigation water distribution manifold 160, and/or may be configured to receive irrigation water 32 from the irrigation water distribution manifold. Irrigation water-discharge region 184 may be arranged on an opposed second side of the flood tray, which may be proximal to irrigation water collection manifold 170, and/or may be configured to provide the irrigation water to the irrigation water collection manifold. Irrigation water-discharge region 184 may include and/or be a recessed irrigation water collection region 184 that may be configured to collect irrigation water 32 from a remainder of each flood tray and/or to provide the irrigation water to the irrigation water collection manifold and/or to elongate irrigation water collection trays 172 of the irrigation water collection manifold.

Flood trays 180 further may include a support region 188. Support region 188 may extend between irrigation water-receiving region 182 and irrigation water collection region 184 and may be configured to support growth media 210 for plants 220 and/or to support at least one container 200 that may contain the growth media. In such a configuration, flow of irrigation water 32 across support region 188 may permit and/or facilitate absorption of the irrigation water by growth media 210, thereby watering plants 220.

In some examples, flood trays 180 may include at least one cart interlock structure 190. Cart interlock structure 190, when present, may be configured to operatively interlock with support frame 110 and/or with tray interlock structure 128 of the support frame, such as to retain flood trays 180 on and/or within cart 100 and/or to resist inadvertent and/or unexpected separation of the flood trays from the cart. Examples of cart interlock structure 190 include a recessed region and/or a recessed channel that may be defined within the flood trays. In some examples, flood trays 180 may include additional recessed regions and/or recessed channels, which may not necessarily interlock with a corresponding tray interlock structure when the flood trays are positioned on the cart. Instead, these additional recessed regions and/or recessed channels may permit a picking device, such as a fork, to remove flood trays 180 from the cart and/or to position the flood trays on the cart.

In some examples, flood trays 180 may be removed and/or separated from a portion of cart 100, such as to permit and/or facilitate repair, replacement, and/or cleaning of the flood trays. With this in mind, cart 100 and/or support frame 110 thereof may be configured to provide access for selective removal of a selected flood tray 180 from a corresponding tray support region 112. This access for selective removal may be from a side of the support frame, and the support frame may be configured such that flood trays 180 may be removed while plants 220 are supported thereon. Additionally or alternatively, and when the plurality of elongate flood trays is supported by a given tray support region 112, cart 100 and/or support frame 110 thereof may be configured to permit and/or facilitate removal of all elongate flood trays within given tray support region 112 at once, or together.

As illustrated in dashed lines in FIG. 2 and in solid lines in FIG. 4, cart 100 may include containers 200. Containers 200 may be positioned on and/or supported by flood trays 180. Examples of containers 200 include media flats and/or a plurality of plug trays.

As illustrated in dashed lines in FIG. 2, cart 100 may include growth media 210 for plants 220. Growth media 210 may be supported, or operatively supported, by flood trays 180. In some examples, carts 100 may include containers 200, and growth media 210 may be contained within the containers. In other examples, growth media 210 may be directly supported by flood trays 180. As an example, growth media 210 may define a growth media mat, or a pre-formed growth media mat, such as may be formed and/or defined from peat, coir, and/or other natural and/or artificial fibers. In such a configuration, carts 100 may include growth media 210 but are not necessarily required to also include containers 200.

FIG. 5 illustrates cart 100 being positioned on shelf 22 of racking system 20. In the example of FIG. 5, shelf 22 of racking system 20 is defined by three horizontals 28, and the arrow at 102 illustrates the path that the cart takes when positioned on the shelf. Also in the example of FIG. 5, racking system 20 includes electrical outlet 50 in the form of a plurality of bus bars 54, such as a first bus bar 56 and a second bus bar 58, which together may be utilized to provide the electric current to the cart. Bus bars 54 may be spaced-apart from one another in at least one, in at least two, or even in three dimensions.

First bus bar 56 may include and/or be a cart stop 57 for cart 100, and the cart may be fully inserted onto shelf 22 when at least a portion of the cart contacts, physically contacts, and/or electrically contacts cart stop 57. Second bus bar 58 may include and/or may be defined by support frame receptacle 24, which is discussed in more detail herein and may be configured to orient, or to correctly orient, cart 100 relative to shelf 22.

Electrical conduits 51, such as electrically conductive cables and/or wires, may provide the electric current to one bus bar 54 and/or may interconnect another bus bar 54 to ground. In some examples, first bus bar 56 may function as a positive terminal, while second bus bar 58 may function as a negative terminal; however, this specific configuration is not required of all examples.

As discussed, FIG. 5 illustrates shelf 22 as being defined by three horizontals 28. Such a configuration may permit electrical conduits 52 each to extend between adjacent, and different, corresponding pairs of horizontals 28. Such a configuration may protect electrical conduits 52 from shorting together and/or from damage.

Also in the example of FIG. 5, cart 100 includes an electrical input structure 148 in the form of a contacting structure 149, a pair of contacting structures 149, or a pair of spaced-apart contacting structures 149, which may be spaced-apart from one another in at least one, in at least two dimensions, or even in three dimensions. Additionally or alternatively, a relative spacing between contacting structures 149 may correspond to a relative spacing between bus bars 54. Contacting structures 149 are configured to contact, or to electrically contact, corresponding bus bars 54 when cart 100 is positioned, or fully positioned, on shelf 22, thereby permitting the electric current to flow to and/or to power the cart.

In some examples, such as when the cart includes a corresponding cart light source driver, this may include powering the cart light source driver, which in turn may power light sources of the cart. In some examples, such as when the racking system includes a corresponding rack light source driver, this may include providing an electrical output from the rack light source driver directly to the light sources of the cart. Stated another way, and in some examples, modular plant growing system 10 and/or cart 100 thereof may be configured such that positioning, correctly positioning, and/or fully positioning cart 100 on shelf 22 causes light sources of the cart to automatically be powered and/or to automatically turn on. Such a configuration may indicate, to a user of the modular plant growing system, that the cart is correctly positioned on the shelf. Additionally or alternatively, such a configuration may decrease a need for a separate and/or manual electrical connection to be established, such as utilizing a manually connected input plug, thereby decreasing time and/or labor costs associated with operation of modular plant growing systems 10.

Electrical outlet 50, bus bars 54, electrical input structures 148, and/or contacting structures 149 may be configured only to permit the electric current to be provided to the cart at the correct, or at a predetermined, polarity. With this in mind, electrical outlet 50, bus bars 54, electrical input structures 148, and/or contacting structures 149 may be keyed and/or may include one or more physical interlock structures that permit an electrical connection between cart 100 and racking system 20 with, or only with, the correct polarity. As an example, the positive terminal of electrical outlet 50 may be configured to form the electrical connection with the positive terminal of electrical input structure 148 but not with the negative terminal of the electrical input structure. As another example, the negative terminal of electrical outlets 50 may be configured to form the electrical connection with the negative terminal of electrical input structure 148 but not with the positive terminal of the electrical input structure. Examples of electrical outlets 50, bus bars 54, electrical input structures 148, and/or contacting structures 149 include a plug, a keyed plug, a blade and socket assembly, and/or a keyed blade and socket assembly. A more specific example of electrical outlet 50, of bus bars 54, of electrical input structure 148, and/or of contacting structures 149 includes an Anderson Powerpole® electrical connector.

In a specific example, and with continued reference to FIG. 5, first bus bar 56 may include and/or be the positive terminal of electrical outlet 50 and second bus bar 58 may include and/or be the negative terminal of electrical outlet 50. First bus bar 56 may form the electrical connection with cart 100 via contact with a corresponding contacting structure 149, which may be spring-loaded and/or resilient. Second bus bar 58 may form the electrical connection with cart 100 via a blade socket assembly that includes a male component, which may be in electrical communication with second bus bar 58, and a female component, which may form a corresponding contacting structure 149.

As discussed in more detail herein, modular plant growing systems 10 and/or carts 100 thereof additionally or alternatively may be configured such that irrigation water may be provided to the cart when the cart is correctly positioned on the shelf and/or responsive to the cart being correctly positioned on the shelf. As an example, cart stop 57 and/or support frame receptacle 24 may be configured to interact with cart 100 such that the irrigation water may flow, or even gravity feed, from water connection 34 to irrigation water distribution manifold 160 of FIG. 1 when the cart is correctly and/or fully positioned on the shelf. This may include actuation, mechanical actuation, and/or electrical actuation, of valve 36, when present, to permit and/or facilitate the irrigation water flow. This actuation may be responsive to and/or a result of the cart being correctly and/or fully positioned on the shelf. As another example, cart stop 57 and/or support frame receptacle 24 may be configured to interact with cart 100 such that irrigation water 32 may flow, or even gravity feed, from irrigation water collection manifold 170 to drain system 40 of FIG. 1 when the cart is correctly and/or fully positioned on the self.

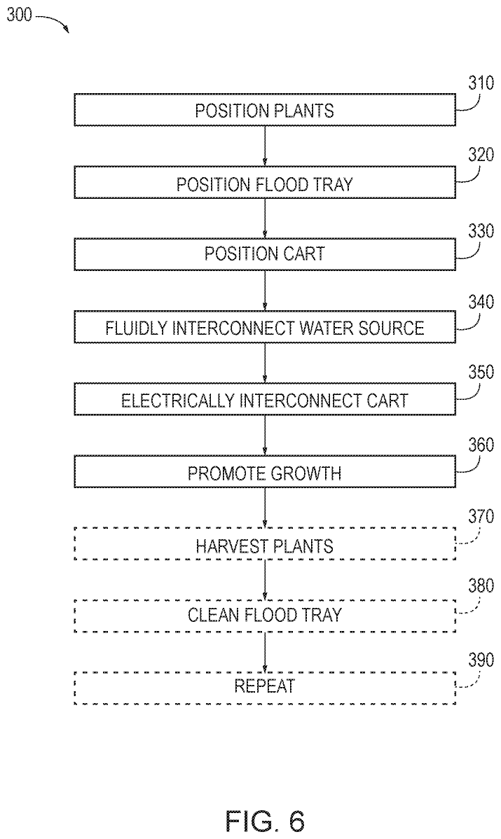

FIG. 6 is a flowchart depicting methods 300, according to the present disclosure, of growing plants indoors. Methods 300 include positioning plants at 310 and positioning a flood tray at 320. Methods 300 also include positioning a cart at 330 and fluidly interconnecting a water source at 340. Methods 300 further include electrically interconnecting the cart at 350 and promoting growth at 360. Methods 300 further may include harvesting plants at 370, cleaning the flood tray at 380, and/or repeating at least a portion of the methods at 390.

Positioning plants at 310 may include positioning a plurality of plants within growth media. Additionally or alternatively, the positioning at 310 may include positioning the plurality of plants on a plurality of flood trays. As used herein, the term “plants” may refer to any suitable organism that may be grown utilizing modular plant growing systems 10 and/or carts 100 that are discussed in more detail herein. Examples of plants that may be positioned during the positioning at 310 includes seeds, unsprouted seeds, sprouted seeds, and/or seedlings. Examples of the flood trays are disclosed herein with reference to flood trays 180.

Positioning the flood tray at 320 may include positioning at least one flood tray on each tray support region of a plurality of tray support regions that may be formed and/or defined by a cart. Examples of the cart are disclosed herein with reference to cart 100. Examples of the tray support regions are disclosed herein with reference to tray support regions 112. The positioning at 320 may be performed with any suitable timing and/or sequence during methods 300. As an example, the positioning at 320 may be performed prior to the positioning at 310, subsequent to the positioning at 310, and/or prior to the positioning at 330.

Positioning the cart at 330 may include positioning the cart on a corresponding shelf of a racking system. Examples of the racking system are disclosed herein with reference to racking system 20.

The positioning at 330 may be performed in any suitable manner. As an example, the positioning at 330 may include rolling the cart toward and/or into the racking system. As another example, the positioning at 330 may include utilizing a forklift and/or a lift truck to position the cart on the corresponding shelf. This may include operatively engaging forks of the forklift with forklift receptacles of the cart. Examples of the forklift receptacles are disclosed herein with reference to forklift receptacles 130.

Fluidly interconnecting the water source at 340 may include fluidly interconnecting a water source of the racking system with an irrigation water distribution manifold of the cart. Examples of the water source are disclosed herein with reference to water source 30. Examples of the irrigation water distribution manifold are disclosed herein with reference to irrigation water distribution manifold 160.

In some examples, the fluidly interconnecting at 340 may be performed, may be automatically performed, and/or may be responsive to the positioning at 330. As an example, the positioning at 330 may include positioning such that a water connection of the shelf aligns with an inlet to the irrigation water distribution manifold of the cart when the cart is positioned, correctly positioned, and/or fully positioned on the shelf, such as to permit and/or to facilitate gravity flow of the irrigation water into the water distribution manifold from the water connection.

In some examples, the fluidly interconnecting at 340 additionally or alternatively may include fluidly interconnecting an irrigation water collection manifold of the cart with a drain system of the racking system. As an example, the positioning at 330 may include positioning such that the drain system aligns with the irrigation water collection manifold of the cart when the cart is positioned, correctly positioned, and/or fully positioned on the shelf, such as to permit and/or to facilitate gravity flow of the irrigation water into the drain system from the irrigation water collection system.

Electrically interconnecting the cart at 350 may include electrically interconnecting the cart with the racking system. As an example, the electrically interconnecting at 350 may include electrically interconnecting an electrical input structure of the cart with an electrical outlet of the racking system. Examples of the electrical input structure are disclosed herein with reference to electrical input structure 148. Examples of the electrical outlet are disclosed herein with reference to electrical outlet 50.

In some examples, the cart may include a cart light source driver. In some such examples, the electrically interconnecting at 350 may include electrically interconnecting a driver electrical input of the cart light source driver of the cart with the electrical outlet of the racking system. Examples of the driver electrical input are disclosed herein with reference to driver electrical input 152. Examples of the cart light source driver are disclosed herein with reference to cart light source driver 150. Examples of the electrical outlet are disclosed herein with reference to electrical outlet 50.

In some examples, the racking system may include a rack light source driver. In some such examples, the electrically interconnecting at 350 may include electrically interconnecting an output from the rack light source driver to the cart.

In some examples, the electrically interconnecting at 350 may include manually establishing the electrical interconnection. In some examples, the electrically interconnecting at 350 may be performed, may be automatically performed, and/or may be responsive to the positioning at 330. As an example, the positioning at 330 may include positioning such that the electrical input structure of the cart contacts, or electrically contacts, one or more bus bars of the racking system when the cart is positioned, correctly positioned, and/or fully positioned on the shelf, such as to permit and/or to facilitate flow of electric current from the electrical outlet and/or to the cart.

Promoting growth at 360 may include promoting growth of the plants and may be performed in any suitable manner. As an example, the promoting at 360 may include selectively providing irrigation water from the water source to the water distribution manifold to flood the plurality of trays with irrigation water. Stated another way, the promoting at 360 may include selectively irrigating the plurality of plants. As another example, the promoting at 360 may include selectively illuminating the plurality of plants with light from a plurality of light sources of the cart. Stated another way, the promoting at 360 may include promoting, or selectively promoting, photosynthesis within the plurality of plants. In some examples, the selectively illuminating may be performed responsive to and/or as a result of the positioning at 330, such as when the positioning at 330 automatically produces the electrically interconnecting at 350.

It is within the scope of the present disclosure that methods 300 may include performing the promoting at 360 for at least a threshold growth time period prior to the harvesting at 370. Examples of the threshold growth time period include time periods of at least 2 days, at least 4 days, at least 6 days, at least 8 days, at least 10 days, at least 12 days, at least 14 days, at least 16 days, at least 18 days, at least 20 days, at most 30 days, at most 25 days, at most 20 days, at most 15 days, and/or at most 10 days. The promoting at 360 may include selectively initiating and/or ceasing the selectively providing irrigation water and/or the selectively illuminating any suitable number of times during the threshold growth time period.

Harvesting plants at 370 may be performed subsequent to the promoting at 360. The harvesting at 370 may include harvesting the plants in any suitable manner. As an example, the harvesting at 370 may include removing the cart from the shelf of the racking system. As another example, the harvesting at 370 may include removing at least one flood tray, or even a plurality of flood trays, from each tray support region of the cart. As yet another example, the harvesting at 370 may include separating an edible portion of each plant of the plurality of plants from a remainder of each plant. As another example, the harvesting at 370 may include packaging the edible portion of each plant, such as to permit and/or facilitate storage and/or shipment of the edible portion of the plant.

Cleaning the flood tray at 380 may be performed subsequent to the promoting at 360, subsequent to the harvesting at 370, and/or at least partially concurrently with the harvesting at 370 and may be performed in any suitable manner. As an example, the cleaning at 380 may include utilizing a tray cleaning device to clean the flood tray. As discussed, the cart may support a plurality of flood trays. With this in mind, the cleaning at 380 may include cleaning each flood tray of the plurality of flood trays. The cleaning at 380 may include sterilizing the flood tray and/or decreasing a potential for contact between plants and contaminants and/or disease organisms via the flood tray.

Repeating at least the portion of the methods at 390 may include repeating any suitable portion of methods 300 in any suitable order and/or in any suitable manner. As an example, the cart may be a first cart. Under these conditions, the repeating at 390 may include repeating at least the positioning at 310, the positioning at 320, and the positioning at 330 to position a plurality of carts, each supporting a corresponding plurality of plants, on the racking system. As another example, the repeating at 390 may include repeating the fluidly interconnecting at 340 and/or the electrically interconnecting at 350 for each cart of the plurality of carts. As yet another example, the repeating at 390 may include performing the promoting at 360 with each cart of the plurality of carts. As another example, the repeating at 390 may include repeating the harvesting at 370 to harvest a corresponding plurality of plants from each cart of the plurality of carts. As yet another example, and subsequent to the cleaning at 380, the repeating at 390 may include re-using the flood tray to repeat the positioning at 310.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A cart configured to support indoor growth of plants, the cart comprising:

a support frame including a plurality of tray support regions;

a plurality of light sources operatively attached to the support frame, wherein at least one light source of the plurality of light sources is positioned vertically above each tray support region of the plurality of tray support regions;

optionally a cart light source driver operatively attached to the support frame, wherein the cart light source driver includes a driver electrical input configured to receive an input electric current and a driver electrical output configured to provide an output electric current to the plurality of light sources;

an electrical input structure configured to receive an electric current, optionally wherein the electrical input structure is configured to provide the electric current to, or directly to, the plurality of light sources, and further optionally wherein the electrical input structure is configured to provide the electric current to the cart light source driver as the driver electrical input;

an irrigation water distribution manifold configured to provide irrigation water to each tray support region of the plurality of tray support regions; and

an irrigation water collection manifold configured to receive unused irrigation water from each tray support region of the plurality of tray support regions.

A2. The cart of paragraph A1, wherein the support frame is a tubular, or an at least partially tubular, support frame.

A3. The cart of any of paragraphs A1-A2, wherein the support frame includes a lower tray support region and a plurality of upper tray support regions.

A4. The cart of paragraph A3, wherein the cart light source driver is operatively attached to, and optionally operatively attached to an underside of, the lower tray support region.

A5. The cart of any of paragraphs A3-A4, wherein a corresponding light source of the plurality of light sources is operatively attached to, and optionally operatively attached to an underside of, each upper tray support region of the plurality of upper tray support regions.

A6. The cart of any of paragraphs A1-A5, wherein the support frame further includes an upper light source support region, wherein an upper light source of the plurality of light sources is operatively attached to the upper light source support region.

A7. The cart of any of paragraphs A1-A6, wherein the plurality of tray support regions is arranged in a vertical stack of tray support regions.

A8. The cart of any of paragraphs A1-A7, wherein the support frame defines a square, or an at least substantially square, frame footprint.

A9. The cart of any of paragraphs A1-A8, wherein the plurality of tray support regions includes at least one of:

(i) at least 2, at least 3, at least 4, at least 6, or at least 8 tray support regions; and

(ii) at most 20, at most 15, at most 10, at most 8, at most 6, at most 5, or at most 4 tray support regions.

A10. The cart of any of paragraphs A1-A9, wherein the support frame further includes a mobile base, optionally that includes a plurality of casters.

A11. The cart of any of paragraphs A1-A10, wherein the support frame further includes a frame interlock structure configured to operatively interlock the support frame with a racking system configured to support a plurality of carts in a 2-dimensional array of carts.

A12. The cart of any of paragraphs A1-A11, wherein the support frame further includes a tray interlock structure configured to operatively interlock each tray support region of the plurality of tray support regions with at least one corresponding tray.

A13. The cart of any of paragraphs A1-A12, wherein the support frame at least partially defines a forklift receptacle configured to permit a forklift to selectively position the cart on a/the racking system and remove the cart from the racking system.

A14. The cart of any of paragraphs A1-A13, wherein a plurality of corresponding light sources of the plurality of light sources is positioned vertically above each tray support region of the plurality of tray support regions.

A15. The cart of paragraph A14, wherein the plurality of corresponding light sources includes at least one of:

(i) at least 2, at least 3, at least 4, or at least 5 light sources of the plurality of light sources; and

(ii) at most 8, at most 6, at most 5, at most 4, or at most 3 light sources of the plurality of light sources.

A16. The cart of any of paragraphs A1-A15, wherein the plurality of light sources includes a plurality of light emitting diode arrays.

A17. The cart of paragraph A16, wherein the plurality of light emitting diode arrays includes a plurality of linear light emitting diode arrays.

A18. The cart of any of paragraphs A1-A17, wherein the cart light source driver includes a light emitting diode cart light source driver.

A19. The cart of any of paragraphs A1-A18, wherein the driver electrical input is configured to receive the drive electric input from a corresponding electrical outlet of a/the racking system configured to support a/the plurality of carts in a/the 2-dimensional array of carts.

A20. The cart of any of paragraphs A1-A19, wherein the driver electrical output includes at least one driver output plug configured to electrically interconnect with a corresponding light source plug of at least one light source of the plurality of light sources.

A21. The cart of any of paragraphs A1-A20, wherein the cart light source driver is configured to modify the input electric current to generate the output electric current.

A22. The cart of any of paragraphs A1-A21, wherein the irrigation water distribution manifold includes a plurality of emitters, wherein at least one emitter of the plurality of emitters is configured to provide irrigation water to a corresponding tray support region of the plurality of tray support regions.

A23. The cart of any of paragraphs A1-A22, wherein the irrigation water collection manifold includes a plurality of elongate irrigation water collection trays, optionally wherein each elongate irrigation water collection tray of the plurality of elongate irrigation water collection trays is configured to extend along a length of at least one side of a corresponding tray support region of the plurality of tray support regions.

A24. The cart of paragraph A23, wherein the irrigation water collection manifold further includes a drain conduit configured to collect irrigation water from the plurality of elongate irrigation water collection trays.

A25. The cart of any of paragraphs A1-A24, wherein the cart further includes a plurality of flood trays, optionally wherein at least one flood tray of the plurality of flood trays is supported by each tray support region of the plurality of tray support regions.

A26. The cart of paragraph A25, wherein the plurality of flood trays includes a plurality of elongate flood trays, and further wherein a subset of the plurality of elongate flood trays is supported by each tray support region of the plurality of tray support regions.

A27. The cart of paragraph A26, wherein the subset of the plurality of elongate flood trays includes at least one of:

(i) at least 2, at least 3, at least 4, at least 5, or at least 6 elongate flood trays; and

(ii) at most 8, at most 6, at most 5, at most 4, or at most 3 elongate flood trays.

A28. The cart of any of paragraphs A26-A27, wherein, within each tray support region, the subset of the plurality of elongate flood trays is arranged in a square, or an at least substantially square, shape.

A29. The cart of any of paragraphs A25-A28, wherein each flood tray of the plurality of flood trays includes an irrigation water-receiving region and an irrigation water discharge region.

A30. The cart of any of paragraphs A25-A29, wherein the irrigation water-receiving region is arranged on a first side of each flood tray, and further wherein the irrigation water-discharge region is arranged on an opposed second side of each flood tray.

A31. The cart of any of paragraphs A25-A30, wherein the irrigation water discharge region includes a recessed irrigation water collection region configured to collect irrigation water from a remainder of each flood tray and to provide collected irrigation water to the irrigation water collection manifold and optionally to an/the elongate irrigation water collection tray of the irrigation water collection manifold.

A32. The cart of any of paragraphs A25-A31, wherein each flood tray includes a support region that extends between the irrigation water-receiving region and the irrigation water discharge region.

A33. The cart of paragraph A32, wherein the support region is configured to at least one of:

(i) support growth media for the plants; and

(ii) support at least one container configured to contain growth media for the plants.

A34. The cart of any of paragraphs A25-A33, wherein each flood tray of the plurality of flood trays includes at least one cart interlock structure configured to operatively interlock with at least one of:

(i) the support frame; and

(ii) a corresponding tray interlock structure of the support frame.

A35. The cart of any of paragraphs A25-A34, wherein the support frame is configured to provide access for selective removal of a selected flood tray of the plurality of flood trays from a corresponding tray support region of the plurality of tray support regions.

A36. The cart of any of paragraphs A25-A35, wherein the cart further includes a plurality of containers, wherein at least one container of the plurality of containers is positioned on each flood tray of the plurality of flood trays.

A37. The cart of paragraph A36, wherein the plurality of containers includes at least one of:

(i) a plurality of media flats; and

(ii) a plurality of plug trays.

A38. The cart of any of paragraphs A25-A37, wherein the cart further includes growth media for the plants.

A39. The cart of paragraph A38, wherein a portion of the growth media is operatively supported by each flood tray of the plurality of flood trays.

A40. The cart of any of paragraphs A38-A39, wherein the growth media is positioned within a/the plurality of containers.

A41. The cart of any of paragraphs A1-A40, wherein the irrigation water distribution manifold is configured to gravity feed irrigation water to the plurality of flood trays.

A42. The cart of any of paragraphs A1-A41, wherein an inlet to the irrigation water distribution manifold is positioned vertically above at least one of:

(i) an uppermost flood tray of a/the plurality of flood trays; and

(ii) an uppermost tray support region of the plurality of tray support regions.

A43. The cart of any of paragraphs A1-A42, wherein the irrigation water distribution manifold and the irrigation water collection manifold are positioned such that irrigation water flows from an/the inlet to the irrigation water distribution manifold to an outlet from the irrigation water collection manifold under the influence of gravity.

A44. The cart of any of paragraphs A1-A43, wherein the cart is configured for at least one of:

(i) a series flow irrigation configuration; and

(ii) a parallel flow irrigation configuration.

A45. The cart of any of paragraphs A1-A44, wherein the electrical input structure includes a pair of spaced-apart contacting structures.

B1. A modular plant growing system, comprising:

a racking system including a plurality of shelves; and

a plurality of carts of any of paragraphs A1-A45.

B2. The modular plant growing system of paragraph B1, wherein the modular plant growing system further includes a water source configured to provide irrigation water to a corresponding irrigation water distribution manifold of each cart of the plurality of carts.

B3. The modular plant growing system of paragraph B2, wherein the water source includes a plurality of water connections, wherein each water connection of the plurality of water connections is configured to:

(i) be selectively engaged with the corresponding irrigation water distribution manifold of each cart of the plurality of carts to provide irrigation water to the corresponding irrigation water distribution manifold; and

(ii) be selectively disengaged from the corresponding irrigation water distribution manifold.

B4. The modular plant growing system of paragraph B3, wherein each water connection further includes a corresponding valve configured to selectively restrict flow of irrigation water therethrough.

B5. The modular plant growing system of any of paragraphs B2-B4, wherein the water source is oriented to automatically provide gravity flow of the irrigation water to an/the inlet to the corresponding irrigation water distribution manifold when each cart is fully inserted into a corresponding shelf of the plurality of shelves.

B6. The modular plant growing system of any of paragraphs B1-B5, wherein the modular plant growing system further includes a drain system configured to receive irrigation water from a corresponding irrigation water collection manifold of each cart of the plurality of carts.

B7. The modular plant growing system of paragraph B6, wherein the drain system is oriented to automatically receive irrigation water from an/the outlet of the irrigation water collection manifold via gravity flow when each cart is fully inserted into a corresponding shelf of the plurality of shelves.

B8. The modular plant growing system of any of paragraphs B1-B7, wherein the modular plant growing system further includes a plurality of electrical outlets, wherein each electrical outlet of the plurality of electrical outlets is configured to electrically interconnect with at least one of:

(i) a/the driver electrical input of a corresponding cart light source driver of a corresponding cart of the plurality of carts; and

(ii) the plurality of light sources of the corresponding cart of the plurality of carts.

B9. The modular plant growing system of paragraph B8, wherein each electrical outlet of the plurality of electrical outlets includes a plurality of bus bars including a first bus bar and a second bus bar, wherein the plurality of bus bars is positioned to automatically form an electrical connection with the corresponding cart when the corresponding cart is fully inserted into a corresponding shelf of the plurality of shelves.

B10. The modular plant growing system of paragraph B9, wherein each shelf of the plurality of shelves includes a plurality of horizontals, and further wherein each bus bar of the plurality of bus bars extends between adjacent, and different, corresponding pairs of horizontals.

B11. The modular plant growing system of any of paragraphs B9-B10, wherein a/the cart stop defines the first bus bar.

B12. The modular plant growing system of any of paragraphs B9-B11, wherein a/the support frame receptacle defines the second bus bar.

B13. The modular plant growing system of any of paragraphs B9-B12, wherein the corresponding cart is configured to automatically illuminate the plurality of light sources responsive to the corresponding cart being fully inserted into the corresponding shelf.

B14. The modular plant growing system of any of paragraphs B1-B13, wherein the modular plant growing system further includes a plurality of support frame receptacles, wherein each support frame receptacle of the plurality of support frame receptacles is configured to operatively interlock with a corresponding frame interlock structure of a corresponding cart of the plurality of carts.

B15. The modular plant growing system of any of paragraphs B1-B14, wherein the modular plant growing system further includes a plurality of cart stops, wherein each cart stop of the plurality of cart stops is configured to contact a corresponding cart when the corresponding cart is fully inserted into a corresponding shelf of the plurality of shelves.

B16. The modular plant growing system of any of paragraphs B1-B15, wherein the racking system includes a rack light source driver configured to provide the electric current to the plurality of light sources of the plurality of carts via the electrical input structure.

C1. A method of growing plants indoors, the method comprising:

positioning a plurality of plants within growth media and on a plurality of flood trays;

positioning at least one flood tray of the plurality of flood trays on each tray support region of a plurality of tray support regions of a cart;

positioning the cart on a corresponding shelf of a racking system;

fluidly interconnecting a water source with an irrigation water distribution manifold of the cart;

electrically interconnecting an electrical outlet an electrical input structure of the cart; and

promoting growth of the plurality of plants by:

(i) selectively providing irrigation water from the water source and to the irrigation water distribution manifold to flood the plurality of flood trays with irrigation water; and

(ii) selectively illuminating the plurality of plants with light from a plurality of light sources of the cart.

C2. The method of paragraph C1, wherein, subsequent to the promoting growth, the method further includes harvesting the plurality of plants.

C3. The method of paragraph C2, wherein the harvesting includes at least one of:

(i) removing the cart from the shelf of the racking system;

(ii) removing at least one, and optionally a plurality of, flood trays from each tray support region of the cart; and

(iii) separating an edible portion of each plant of the plurality of plants from a remainder of each plant.

C4. The method of any of paragraphs C2-C3, wherein, subsequent to the harvesting, the method further includes cleaning each flood tray of the plurality of flood trays.

C5. The method of any of paragraphs C1-C4, wherein the cart is a first cart, and further wherein the method includes repeating the method to at least one of:

(i) position a plurality of carts on a plurality of corresponding shelves and promote growth of a corresponding plurality of plants positioned on each cart of the plurality of carts; and

(ii) harvest the corresponding plurality of plants from each cart in the plurality of carts.

C6. The method of any of paragraphs C1-C5, wherein the fluidly interconnecting is responsive to the positioning.

C7. The method of any of paragraphs C1-C6, wherein the fluidly interconnecting includes orienting a water connection of the water source with an inlet to the irrigation water distribution manifold such that irrigation water flows, under the influence of gravity, from the water source into the irrigation water distribution manifold.

C8. The method of paragraph C7, wherein the fluidly interconnecting includes aligning the water connection with the inlet.

C9. The method of any of paragraphs C1-C8, wherein the electrically interconnecting is responsive to the positioning.

C10. The method of any of paragraphs C1-C9, wherein the electrically interconnecting includes electrically contacting a plurality of contacting structures of the cart with a corresponding plurality of bus bars.

C11. The method of any of paragraphs C1-C10, wherein the method further includes automatically illuminating the plurality of plants responsive to the positioning.

C12. The method of any of paragraphs C1-C11, wherein the cart includes the cart of any of paragraphs A1-A45.

C13. The method of any of paragraphs C1-C11, wherein the method is performed utilizing the modular growing system of any of paragraphs B1-B16.

### INDUSTRIAL APPLICABILITY

The systems and methods disclosed herein are applicable to the horticultural and indoor plant growth industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A cart configured to support indoor growth of plants, the cart comprising:
a support frame including a plurality of tray support regions;
a plurality of light sources operatively attached to the support frame, wherein at least one light source of the plurality of light sources is positioned vertically above each tray support region of the plurality of tray support regions;
an electrical input structure configured to receive an electric current, wherein the electrical input structure includes a pair of spaced-apart contacting structures that are spaced-apart from one another in at least 2 dimensions;
an irrigation water distribution manifold configured to provide irrigation water to each tray support region of the plurality of tray support regions; and
an irrigation water collection manifold configured to receive unused irrigation water from each tray support region of the plurality of tray support regions;
wherein the irrigation water distribution manifold and the irrigation water collection manifold are positioned such that irrigation water flows from an inlet to the irrigation water distribution manifold to an outlet from the irrigation water collection manifold under the influence of gravity.

2. The cart of claim 1, wherein the support frame further includes a frame interlock structure configured to operatively interlock the support frame with a racking system configured to support a plurality of carts in a 2-dimensional array of carts.

3. The cart of claim 1, wherein the cart further includes a plurality of flood trays, wherein at least one flood tray of the plurality of flood trays is supported by each tray support region of the plurality of tray support regions.

4. The cart of claim 3, wherein the cart further includes a plurality of containers, wherein at least one container of the plurality of containers is positioned on each flood tray of the plurality of flood trays, wherein the cart further includes growth media for the plants, and further wherein the growth media is positioned within the plurality of containers.

5. The cart of claim 1, wherein the irrigation water distribution manifold is configured to gravity feed irrigation water to a plurality of flood trays.

6. The cart of claim 1, wherein the cart is configured for at least one of:
(i) a series flow irrigation configuration; and
(ii) a parallel flow irrigation configuration.

7. A modular plant growing system, comprising:
a racking system including a plurality of shelves and a plurality of electrical outlets, wherein each electrical outlet of the plurality of electrical outlets includes a plurality of bus bars including a first bus bar and a second bus bar; and
a plurality of carts, wherein each cart of the plurality of carts includes:
(i) a support frame including a plurality of tray support regions;
(ii) a plurality of light sources operatively attached to the support frame, wherein at least one light source of the plurality of light sources is positioned vertically above each tray support region of the plurality of tray support regions;
(iii) an electrical input structure configured to receive an electric current, wherein the electrical input structure includes a pair of spaced-apart contacting structures;
(iv) an irrigation water distribution manifold configured to provide irrigation water to each tray support region of the plurality of tray support regions; and
(v) an irrigation water collection manifold configured to receive unused irrigation water from each tray support region of the plurality of tray support regions;
wherein the plurality of bus bars is positioned to automatically form an electrical connection with the pair of spaced-apart contacting structures of a corresponding cart when the corresponding cart is fully inserted into a corresponding shelf of the plurality of shelves.

8. The modular plant growing system of claim 7, wherein each shelf of the plurality of shelves includes a plurality of horizontals, and further wherein each bus bar of the plurality of bus bars extends between adjacent, and different, corresponding pairs of horizontals.

9. The modular plant growing system of claim 7, wherein the racking system further includes a plurality of cart stops, wherein each cart stop of the plurality of cart stops is configured to contact the corresponding cart when the corresponding cart is fully inserted into the corresponding shelf, and further wherein each cart stop defines a corresponding first bus bar.

10. The modular plant growing system of claim 7, wherein the racking system further includes a plurality of support frame receptacles, wherein each support frame receptacle of the plurality of support frame receptacles is configured to orient the corresponding cart relative to the corresponding shelf, and further wherein each support frame receptacle defines a corresponding second bus bar.

11. The modular plant growing system of claim 7, wherein the pair of spaced-apart contacting structures is spaced-apart in at least 2 dimensions, and further wherein the first bus bar and the second bus bar are spaced-apart from one another in at least 2 dimensions.

12. The modular plant growing system of claim 7, wherein a relative spacing between the pair of spaced-apart contacting structures corresponds to a relative spacing between the first bus bar and the second bus bar.

13. The modular plant growing system of claim 7, wherein the modular plant growing system further includes a water source configured to provide irrigation water to a corresponding irrigation water distribution manifold of each cart of the plurality of carts, wherein the water source is oriented to automatically provide gravity flow of the irrigation water to an inlet to the corresponding irrigation water distribution manifold when each cart is fully inserted into the corresponding shelf.

14. The modular plant growing system of claim 7, wherein the modular plant growing system further includes a drain system configured to receive irrigation water from a corresponding irrigation water collection manifold of each cart of the plurality of carts, wherein the drain system is oriented to automatically receive irrigation water from an outlet of the corresponding irrigation water collection manifold via gravity flow when each cart is fully inserted into the corresponding shelf.

15. The modular plant growing system of claim 7, wherein each shelf of the plurality of shelves includes a plurality of horizontals, and further wherein each bus bar of the plurality of bus bars extends between adjacent, and different, corresponding pairs of horizontals.

16. The modular plant growing system of claim 7, wherein the corresponding cart is configured to automatically illuminate the plurality of light sources responsive to the corresponding cart being fully inserted into the corresponding shelf.

17. The modular plant growing system of claim 7, wherein the racking system includes a rack light source driver configured to provide the electric current to the plurality of light sources of the plurality of carts via the plurality of electrical outlets.

18. A method of growing plants indoors, the method comprising:
positioning a plurality of plants within growth media and on a plurality of flood trays;
positioning at least one flood tray of the plurality of flood trays on each tray support region of a plurality of tray support regions of a cart;
positioning the cart on a corresponding shelf of a racking system;
fluidly interconnecting a water source with an irrigation water distribution manifold of the cart;
electrically interconnecting an electrical outlet to an electrical input structure of the cart, wherein the electrically interconnecting is responsive to the positioning the cart; and
promoting growth of the plurality of plants by:
(i) selectively providing irrigation water from the water source and to the irrigation water distribution manifold to flood the plurality of flood trays with irrigation water; and
(ii) selectively illuminating the plurality of plants with light from a plurality of light sources of the cart.

19. The method of claim 18, wherein the fluidly interconnecting is responsive to the positioning the cart.

20. The method of claim 18, wherein the method further includes automatically illuminating the plurality of plants responsive to the positioning.
